(19) United States
(12) Patent Application Publication
(10) Pub. No.: US 2011/0099473 A1
(43) Pub. Date: Apr. 28, 2011

(54) Input signal processing device for portable device and method of the same

(75) Inventors: Dong Kyun Son, Suwon-si (KR); Dong Han Kang, Suseong-gu (KR); Woo Chan Park, Suseong-gu (KR); Sang Hoon Kang, Suwon-si (KR)

(73) Assignee: Samsung Electronics Co., Ltd., Suwon-si (KR)

(21) Appl. No.: 12/925,316

(22) Filed: Oct. 19, 2010

(30) Foreign Application Priority Data
Oct. 23, 2009 (KR) 10-2009-0101204

(51) Int. Cl. G06F 3/01

(52) U.S. Cl. 715/704

(57) ABSTRACT

A method of processing an input signal of a portable device is provided, including collecting an input signal generated from at least one of an input unit and a touch screen; generating a preset repetitive input signal when the collected input signal corresponds to a preset condition input signal; and using an application that is currently activated based on the repetitive input signal.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Oct. 23, 2009 and assigned Serial No. 10-2009-0101204, the entire disclosure of which is hereby incorporated by reference.

### TECHNICAL FIELD OF THE INVENTION

The present invention relates to a portable device and, more particularly, to an apparatus and a method for processing an input signal of a portable device that can easily support the generation of an input signal performing a repetitive operation.

### BACKGROUND OF THE INVENTION

A portable device is a terminal that supports call function based on portability, while being widely used due to the convenience of usage and the simplicity of carrying. This portable device provides various input modes for various user functions. For instance, the conventional portable device provides a touch screen including a touch panel and a display unit, so that the operation of selecting a specific image to be outputted to the display unit can be processed in the touch panel. The portable device generates a touch event according to a corresponding user operation and, based on this, controls an application corresponding to the user function. In the meantime, the conventional portable device requires a repetitive input signal, e.g., a repetitive touch event generation so as to search a desired item when searching through information or contents. Such repetitive input signal generation can be disadvantageous to a user depending on the situation.

### SUMMARY OF THE INVENTION

To address the above-discussed deficiencies of the prior art, it is a primary object to provide an apparatus and a method for processing an input signal of a portable device that can simplify a repetitive input signal generation and easily control the portable device.

In accordance with an aspect of the present invention, a method of processing an input signal of a portable device includes: collecting an input signal generated from at least one of an input unit and a touch screen; generating a preset repetitive input signal when the collected input signal corresponds to a preset condition input signal; and using an application that is currently activated based on the repetitive input signal.

In accordance with another aspect of the present invention, a portable device for processing an input signal includes: at least one of an input unit and a touch screen configured to generate an input signal; and a controller configured to collect the input signal, generate a preset repetitive input signal when the collected input signal corresponds to a preset condition input signal, and use an application that is currently activated based on the repetitive input signal.

According to the apparatus and method for processing an input signal of a portable device of the present invention, the portable device can be easily operated by performing the simplified operation to control the repetitive input signal generation.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram schematically illustrating a configuration of a portable device according to an exemplary embodiment of the present invention;

FIG. 2 is a drawing illustrating a user interface for setting a repetitive input signal according to an exemplary embodiment of the present invention;

FIG. 3 is a drawing illustrating an operation screen of an application according to the repetitive input signal generation of the present invention; and

FIG. 4 is a flowchart illustrating a method of processing an input signal of a portable device according to an exemplary embodiment of the present invention.

### DETAILED DESCRIPTION OF THE INVENTION

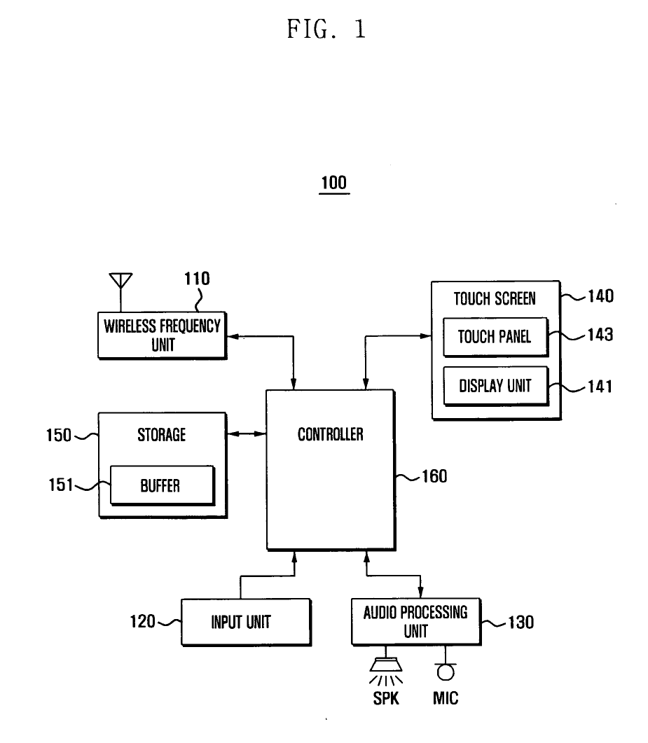

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable device.

FIG. 1 is a block diagram schematically illustrating a configuration of a portable device according to an exemplary embodiment of the present invention.

Referring to FIG. 1, the portable device 100 of the present invention includes a wireless frequency unit 110, an input unit 120, an audio processing unit 130, a touch screen 140, storage 150, and a controller 160. The portable device 100 having such configuration collects an input signal generated from the input unit 120. If the collected input signal is a preset condition input signal, the portable device 100 supports the repetitive operation of the portable device 100, so that it can more conveniently support the operation of portable device 100. Hereinafter, each configuration of portable device 100 is illustrated in detail.

The wireless frequency unit 110 performs the communications channel formation for voice call, the communications channel formation for video telephony, and the communications channel formation for data transmission such as image or message under the control of the controller 160. That is, the wireless frequency unit 110 forms a voice call channel, a data communications channel and a video telephony channel between the mobile communications systems. To this end, the wireless frequency unit 110 includes a wireless frequency transmission unit that up-converts and amplifies the frequency of the transmitted signal and a wireless frequency reception unit that low-noise amplifies the received signal and down-converts the frequency. This wireless frequency unit 110 can be selected and activated according to a touch event generated by a touch panel 143, and can be selected and activated according to an input signal generated by the input unit 120.

In the meantime, the wireless frequency unit 110 generates call log information depending on the activation of call function, can send this to the storage 150 under the control of the controller 160. The call log information can be stored in the storage 150 in a list format. A search for a specific call log information by a user is supported through a menu that supports a search for the specific call log information.

In this process, the call log information may provide numerous items, e.g., about one thousand items, to a user. At this time, the user can generate a simple input signal of the present invention by utilizing the input unit 120 or the touch screen 140 while not performing the repetitive input signal generation so as to search for the specific call log information and, based on this, can easily search a large amount of call log information. The input unit 120 includes a plurality of input keys and function keys for receiving number or character information and setting various functions. The function keys can include a direction key, a side key and a shortcut key that are set to perform a specific function. Moreover, the input unit 120 generates a key signal related to the user setting and the function control of the portable device 100 and sends the key signal to the controller 160. This input unit 120 can be implemented as a qwerty keypad, a 3*4 keypad, and a 4*3 keypad including a plurality of keys. In the case in which the touch screen 140 of the portable device 100 is supported with a full touch screen type, such input unit 120 can be omitted and can be replaced with the touch screen 140. Particularly, the input unit 120 can support the repetitive input signal generation of the present invention according to a repetitive input signal generation mode. For instance, in the repetitive input signal generation mode, a user can perform the operation of generating a preset condition input signal by using the direction key indicating a specific direction among the direction keys in the input unit 120.

For instance, after pressing a direction key of the input unit 120 for a certain time, the user removes the pressure from the direction key and can perform button up. The unit 120 then recognizes the direction key signal generated according to the pressing of the direction key for a certain time as a condition input signal, and can generate a corresponding repetitive input signal, e.g., a repetitive input signal corresponding to the operation of repetitively pressing the generated direction key signal according to a given period.

Here, the given period of the direction key signal can be changed according to the user setting or the intention of the designer and/or can be changed according to a preset operation. The audio processing unit 130 includes a speaker (SPK) for playing audio data transmitted and received in a call, audio data included in a received message, and audio data corresponding to an audio file stored in the storage 150, and a microphone (MIC) for collecting the voice of a user or other audio signals in the call.

This audio processing unit 130 can output sound effects that indicate the entering of the repetitive input signal generation mode, and output corresponding sound effects when generating a specific repetitive input signal in the repetitive input signal generation mode. This output of sound effects can be removed according to user setting. The touch screen 140 includes the display unit 141 and the touch panel 143. This touch screen 140 can have a structure where the touch panel 143 is arranged in the front side of the display unit 141. The size of the touch screen 140 can be determined as the size of the touch panel 143.

In the meantime, in the description of the present invention, a portable device 100 that employs the touch screen 140 is used to illustrate the iteration according to the touch event, but the present invention is not limited to this. That is, the portable device 100 of the present invention can employ only the display unit 141 that does not include a separate touch panel 143, and can support the generation of a specific repetitive input signal based on the input unit 120 in the repetitive input signal generation mode. The display unit 141 displays the information that a user inputted or the information provided to a user as well as various menus of the portable device 100. That is, the display unit 141 can provide various screens according to the usage of the portable device 100, e.g., a stand-by screen, a menu screen, a message write screen, and a call screen. This display unit 141 can be formed of a liquid crystal display, or an organic light emitted diode (OLED). This display unit 141 can have a small size in comparison with the size of the touch panel 143, and can be arranged in the lower portion of the touch panel 143.

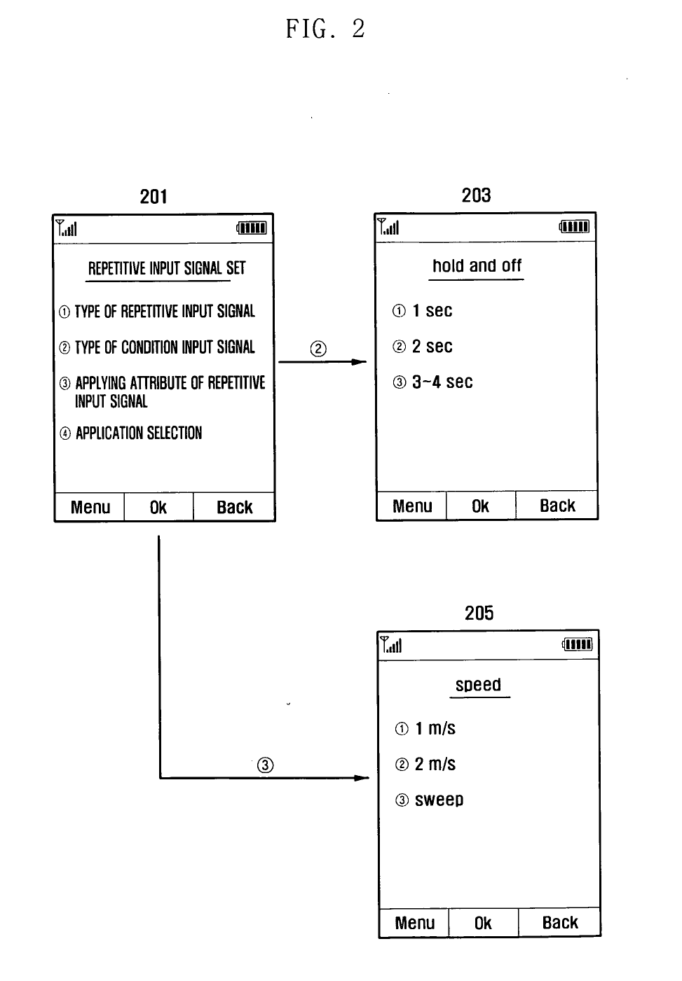

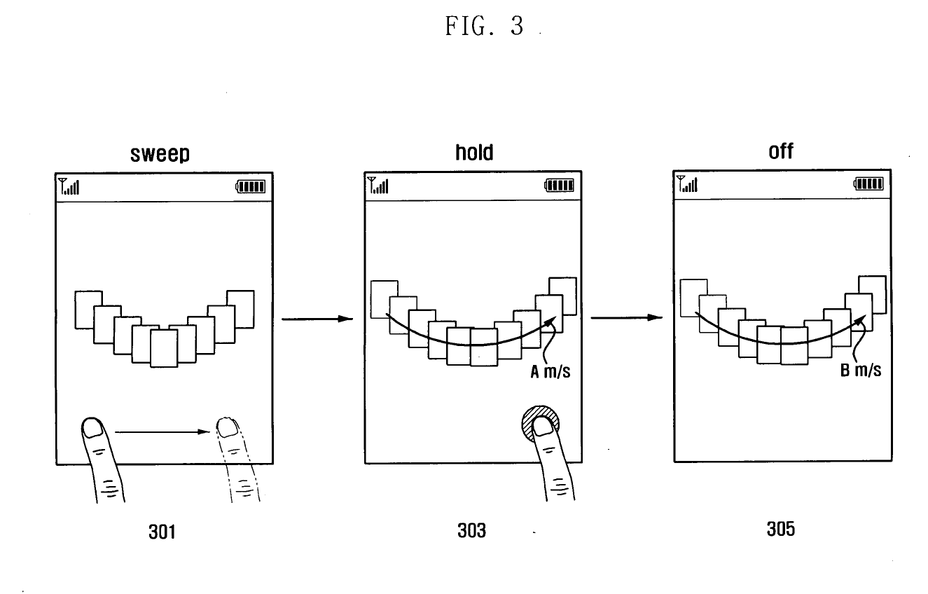

Particularly, the display unit 141 of the present invention may provide a screen that can set the characteristics of the repetitive input signal, and can output a corresponding list according to a preset image output type when a user selects a specific list. And, in case a specific repetitive input signal is generated in the state where the list is outputted, the display unit 141 can move items included in the list or change the display state according to a corresponding repetitive input signal. The user interface outputted on the display unit 141 is illustrated in detail with reference to FIGS. 2 and 3.

While being arranged to cover the display unit 141, the touch panel 143 generates a touch event according to contact with an object or the distance of an approaching object, and can send the generated touch event to the controller 160. At this time, the touch panel 143 is arranged with a matrix type, and sends information regarding the corresponding location on the touch panel 143 and the information about the kind of touch event to the controller 160 with respect to the touch event generated on the touch panel 143. The controller 160 checks the location information and the kind of touch event from the touch event sent from the touch panel 143, checks a specific image of the display unit 141 mapped to a corresponding location, and activates the user function linked to image.

Particularly, when a specific touch event is generated according to a preset user operation in the repetitive input signal generation mode, the touch panel 143 can send a corresponding touch event generated in a specific location to the controller 160. For instance, according to the user operation, the touch panel 143 generates a sweep event that moves a touch-down state in a specific direction while having a given speed or acceleration in the state where a touch-down event is generated in a specific spot and the touch-down event is maintained, a hold event that maintains the touch-down state after the completion of a sweep event, and a touch-up event that unlocks the touch-down state, and can send this to the controller 160. The operation of the touch panel 143 will be illustrated later in detail with reference to drawing.

The storage 150 can store a key map or a menu map for the operation of the touch screen 140 when the portable device 100 is formed of the touch screen 140, as well as an application necessary for the function operation according to the embodiment of the present invention. Here, the key map and the menu map can be various types. That is, the key map can be a keyboard map, a 3*4 key map, and a qwerty key map, and can be a control key map for the operation control of the currently activated application. Moreover, the menu map can be a menu map for the operation control of the currently activated application, can be a menu map that has various menus provided by the portable device 100 as an item. This storage 150 can include a program area and a data area.

The program area can store an operating system (OS) for the booting of the portable device 100 and the operation of the above described elements, and an application for playing various files, e.g., an application for the support of call function depending on the function support of the portable device 100, a web browser for accessing an Internet server, a MP3 application for playing a sound source, an image output application for playing a photo, and an application for playing a moving picture.

Particularly, the program area of the invention can include a repetitive input signal generation program, and a repetitive input signal set program, and a list search application. The repetitive input signal generation program can be loaded to the controller 160 when a user selects and activates an item allocated to a specific menu or activates a hotkey allocated to enter the repetitive input signal generation mode. Moreover, the repetitive input signal generation program can be activated when a specific application program, e.g., a list search application is activated, or can be activated according to a preset condition.

This repetitive input signal generation program may include a routine of collecting an input signal, a routine of checking whether the collected input signal is a condition input signal that satisfies a preset condition, a routine of determining a corresponding input signal as the repetitive input signal when collecting a condition input signal that satisfies a preset condition, and a routine of sending the repetitive input signal to the controller 160 according to a given period and given condition.

The repetitive input signal set program may include a routine of setting a condition of activating the repetitive input signal generation mode, a routine of setting the kind of the repetitive input signal, a routine of setting the kind of condition input signal, and a routine of setting the period and speed of the repetitive input signal. Here, the routine of setting a condition of activating the repetitive input signal generation mode may include a routine of linking to activate in the activation of a specific application, e.g., a list search application.

The list search application can be loaded to the controller 160 in case a specific hotkey of specific item is activated in menu. This list search application may include a routine of supporting a list search of various types. For instance, the search routine supported by the list search application may include a routine for searching various lists that the portable device 100 supports such as a phonebook list search routine, a call log list search routine, a file list search routine, and a contents list search routine.

The list search application may include a routine that can also activate the repetitive input signal generation program in the case of being activated according to the input signal. Moreover, it can include a routine of outputting an alarm, vibration, or a message that indicates entering the repetitive input signal generation mode when an input signal for activating the repetitive input signal generation program is generated in the state where the list search application is activated. Hereinafter, the repetitive input signal generation mode is illustrated based on a function support environment for the list search.

The data area is an area that stores data generated according to the use of portable device 100, can store phonebook information, one or more icons according to the Widget function, and various contents. Moreover, the data area can store a user input inputted through the touch panel 143. Particularly, the data area can include a buffer 151 that can temporarily store a repetitive input signal inputted in a repetitive input signal generation mode. The buffer 151 can store the repetitive input signal and can send a corresponding repetitive input signal to the controller 160 at a given time interval.

In the meantime, the data area can include various lists. That is, the data area can store the phonebook list, the call log list, the file list, and the contents list. The controller 160 controls the power supply to each configuration of the portable device 100 and supports the performance of an initialization process. And, when the initialization process is completed, the controller 160 can control the signal flow so as to support the repetitive input signal generation mode of the present invention with respect to each configuration.

In more detail, in a case where a specific application is activated, a specific menu item is activated, or a specific key is activated, the controller 160 can determine the entering of the repetitive input signal generation mode. If the entering of the repetitive input signal generation mode is determined, the controller 160 collects the input signal generated from the input unit 120 or the touch screen 140, and checks whether the collected input signal is an input signal for the generation of a preset repetitive input signal.

The controller 160 can control the performance of a corresponding function according to the collected input signal in a case where the input signal collected from at least one of the input unit 120 and the touch screen 140 is not a condition input signal for the generation of a preset repetitive input signal. And, the controller 160 controls the storage of the collected input signal in the buffer 151 of the storage 150 in a case where the input signal collected from at least one of the input unit 120 and the touch screen 140 is a condition input signal. The controller 160 controls the operation of the currently activated application based on the repetitive input signal stored in the buffer 151 according to a preset period and condition.

The input signal collection for the generation of a repetitive input signal after entering the repetitive input signal generation mode has been described up to this point, but the present invention is not limited to this. That is, when a specific input signal satisfying the condition input signal is generated without entering a separate repetitive input signal generation mode, the controller 160 of the portable device 100 can determine a corresponding input signal as a condition input signal for the generation of a repetitive input signal.

The controller 160 can control the storage of the repetitive input signal in the buffer 151 and apply the repetitive input signal stored in the buffer 151 to the currently activated application according to a given period. This will be illustrated in detail with reference to drawings showing an example of user interface.

FIG. 2 is a drawing illustrating a repetitive input signal setting screen according to an exemplary embodiment of the present invention. Hereinafter, it is illustrated that the setting user interface is used to support the list search function.

Referring to FIG. 2, the controller 160 of the portable device 100 can output a repetitive input signal set screen to the display unit 141 like screen 201. To this end, user activates the menu item outputted on the display unit 141 or a specific key of the input unit 120, so that user can enter the repetitive input signal set screen. The display unit 141 outputting the repetitive input signal set screen can output the type item of repetitive input signal, the type item of condition input signal, the applying attribute item of repetitive input signal, and the application selection item. The type item of repetitive input signal is an item that determines a function that is to be applied in the activation of a specific application program. User can select “automatic right side scroll function”, “automatic left side scroll function”, and “automatic scroll function” as the kind of the repetitive input signal.

If user selects the function relating to scroll as the kind of the repetitive input signal, the controller 160 of the portable device 100 controls the output of an item that can select the kind of condition input signal so as to determine the generation of a specific condition input signal under which a corresponding repetitive input signal is applied to an application, to the display unit 141. The type item of condition input signal is an item selecting the kind of an input signal that can set based on at least one of the input unit 120 and the touch screen 140.

As for the touch screen 140, the type item of condition input signal is an item that supports to select “hold and off” which generates a touchup event after maintaining the touch-down state of the touch panel 143 for a certain time, “hold, sweep and off” which moves a spot designated by the touch-down event after maintaining the touch-down state for a certain time and generates a touchup event when movement is completed, and “sweep, hold and off” which maintains the touch-down state for a certain time and generates a touchup event that unlocks the touch-down state in a spot where movement is completed when movement is completed after the spot designated by the touch-down event is moved.

Here, it is preferable that the type item of condition input signal is set by the combination of a plurality of touch events so as not to be overlapped with other touch events. The type item of condition input signal supports to select “direction key hold and off”, and “a first direction key hold and off and a second direction key hold and off” based on input unit 120. This type item of condition input signal is designed by a designer and made when the portable device 100 is manufactured to provide certain input signal types so that user may select it.

Moreover, the type of condition input signal can be determined according to user setting. In a case where the portable device 100 supports user setting, the user selects the type item of condition input signal in the repetitive input signal set screen, can generate an input signal that is generated based on at least one of the input unit 120 and the touch screen 140. And then, the controller 160 of the portable device 100 can determine the generated input signal as the type of the condition input signal.

In the meantime, in screen 201, when user determines the type item of condition input signal, the controller 160 of the portable device 100 can control an output of a screen 203 on the display unit 141 so that the detailed environment of the corresponding condition input signal may be determined. For instance, in screen 201, if “hold and off” is selected as the type item of condition input signal, the portable device 100 supports the selection of the detailed environment of “hold and off”, e.g., the time interval of “hold and off” on screen 203.

In screen 203, the controller 160 of the portable device 100 controls an output of the items setting the detailed environment such as 1 sec, 2 sec, and 3˜4 sec on the display unit 141. Here, if user selects the 3˜4 sec item by using at least one of the input unit 120 and the touch screen 140, the controller 160 of the portable device 100 can determine the time range where “hold and off”, which is the condition input signal, is generated as “3˜4 sec” which is the time range of the selected item. In a case in which the touch event generated from the touch screen 140 is a touch event corresponding to “hold and off”, the controller 160 checks whether a corresponding touch event is included in the set time range. And in a case where the corresponding touch event is not included in or deviated from the time range, the controller 160 can control the generation of only the touch event corresponding to “hold and off”.

In the meantime, in a case where the touch event generated from the touch screen 140 is a touch event corresponding to “hold and off”, and in a case where the time range of the generated touch event is within the set range, the controller 160 can determine that the condition input signal is generated. Then, the controller 160 can control the storage of the repetitive input signal corresponding to relevant condition input signals in the buffer 151 based on the generation of the condition input signal and, based on this, can control the generation of the repetitive input signal. Here, the controller 160 of the portable device 100 sets the time of “hold and off”, but the present invention is not limited to this.

For instance, it is assumed that user sets “sweep, hold and off” corresponding to a sweep event moving the touch-down state with a given direction and a given distance as the type item of condition input signal, a hold event maintaining the touch-down state for a certain time after the completion of sweep event, and a touchup event unlocking the touch-down state after a certain time.

And then, the controller 160 of the portable device 100 can control an output of items setting at least one among the movement distance of the sweep event and the time range of the hold event for the detailed environment setting of the selected “sweep, hold and off”, to the display unit 141. And then, the user selects one of movement distance items of the sweep event outputted to the display unit 141, e.g., 1 cm, 2 cm, and 3 cm, and can set the movement distance item of the sweep event.

Moreover, as described above, a user can select the time range item of the hold event and set a specific time range. Therefore, it should be understood that the portable device 100 of the present invention is able to adaptively output a screen that can set corresponding detailed items in the type selection of the condition input signal. In screen 201, in case where the item defining the attribute of the repetitive input signal which is a third item is selected, the controller 160 of the portable device 100 supports the setting of a method by which the repetitive input signal is applied to applications like screen 205.

Accordingly, according to the activation of the application, a user can set the attribute of a change of the screen outputted on the display unit 141. For instance, the controller 160 can control an output of the screen, which can set a speed among the attribute of the automatic scroll function, to the display unit 141. That is, the controller 160 supports a determination of the type item of the repetitive input signal selected by user, e.g., the speed of the automatic scroll function according to the selection of one among 1 m/s, 2 m/s, and the sweep speed item outputted to the display unit 141.

The “sweep speed” item is an item that detects the acceleration of the sweep event and applies it to the automatic scroll function, in the generation of sweep event which a user generates by using the touch screen 140. Here, the present invention is not limited to the above-described three kinds of speed. That is, according to the operation of a user or the intention of the controller designer of the portable device 100, various kinds of speed can be provided to screen 205, and can support a user to directly write to screen 205.

In the meantime, if a user determines the type item of a specific repetitive input signal and the type item of the condition input signal through the repetitive input signal set screen, the controller 160 of the portable device 100 can apply a preset repetitive input signal according to the collection of condition input signals in the activation of a specific application. To this end, the controller 160 of the portable device 100 can support a selection of a fourth item of screen 201 so that the application applying the repetitive input signal generation mode may be selected.

Accordingly, by using the application selection item, a user can select an application that applies the repetitive input signal generation mode, e.g., the music file player, the contents search application, and the list search application such as the call log search program or the phonebook list search program. And then, the controller 160 can determine the point of time of entering the repetitive input signal generation mode and the point of time of unlocking repetitive input signal generation mode based on the setting of the application program selection item selected by user. For instance, according to the setting of the application selection item, the controller 160 unlocks the repetitive input signal generation mode in the state of outputting a standby screen or in the state of watching TV, can automatically activate the repetitive input signal generation mode in the state of outputting a list search screen. An example of applying the list search is illustrated in detail with reference to FIG. 3.

FIG. 3 is a drawing illustrating an example of applying a repetitive input signal of the portable device in the list search according to an exemplary embodiment of the present invention. Hereinafter, it is assumed that the automatic scroll function is selected for the type of the repetitive input signal.

Referring to FIG. 3, when user selects the list search item as a menu item or selects the list search item by inputting a specific key, the controller 160 of the portable device 100 can control an output of a list including an image or a text corresponding to the item of a certain number to the display unit 141 like screen 301. In screen 301, the controller 160 can control an output of a plurality of items to the display unit 141 while controlling at least a part of the image corresponding to respective items to be overlapped with other images in a certain area. Here, the apparatus and method for processing an input signal of the present invention is not limited to a form that the items are outputted to the display unit 141. That is, the controller 160 of the portable device 100 can enumerate respective items top and bottom or right and left without an overlapped area according to a user's setting or designed program, or can control an output of an image corresponding to respective items in a grid form.

In the meantime, in screen 301, when a plurality of items are outputted and the portable device 100 employs the touch screen 140, a user can generate a touch event for a specific item search by using the touch screen 140. That is, a user touches-down one side of the touch screen 140 to generate a touch-down event, and can generate a sweep event moving a spot designated by the touch-down event in a specific direction, e.g., the right while maintaining the touch-down event. And then, the controller 160 can determine that the sweep event is generated through the events generated from the touch screen 140.

The controller 160 controls the item change according to the sweep event, for example, controls an output of the items outputted on the display unit 141 in a certain arrangement while moving to the direction in which the sweep event is generated, e.g., the right. In more detail, the controller 160 moves the image of the items that are arranged in the right side based on the center of the display unit 141 to the right side according to the sweep event while removing the image of the items that move beyond a certain area of the display unit 141.

Moreover, the controller 160 can control an output of images corresponding to items that were not outputted on the display unit 141 to the left area of the display unit 141 before the sweep event is generated. And the controller 160 controls the movement of the images of the items arranged in the left side of the center of display unit 141 to the center of display unit 141, and can control the movement of the images to the right side passing the center when the sweep event is continuously generated. The controller 160 can control a matching of the image movement distance and image variation of the items to the distance of the sweep event generated on the touch screen 140. That is, the controller 160 controls a gradual movement of the image of the items outputted on the display unit 141 in a certain arrangement from the left side to the right side while changing with a certain speed, e.g., “A m/s” corresponding to the speed in which the sweep event is generated.

In the meantime, in a case where the generation of a repetitive input signal is desired, a user can perform the generation of a condition input signal for the generation of a preset repetitive input signal. That is, a user can generate the sweep event (sweep) in screen 301, and can generate a hold event maintaining the touch-down state in a spot where the sweep event is terminated in screen 303. The user generates the hold event (hold) for a certain time in screen 303 and can generate a touchup event (off) unlocking the touch-down state after a certain time is elapsed as shown in screen 305. And then, the controller 160 collects the sweep event, the hold event, and the touchup event and determines whether the three events correspond to the condition input signal for the generation of the repetitive input signal.

If a user or designer sets in such a manner that the repetitive input signal corresponding to the automatic scroll function is generated when the sweep event, the hold event and the touchup event are generated, the controller 160 controls an application of the function being performed according to the automatic scroll function to the currently activated application. That is, the controller 160 can control the image of the items outputted on the display unit 141 to be automatically scrolled in a certain speed, e.g., “B m/s” although the touch event is not generated by a user like screen 305. To this end, the portable device 100 can control the storage of the information relating to the automatic scroll function in the buffer 151 and, based on this, the repetitive performance of the sweep event.

The information relating to the automatic scroll function can be the type of the repetitive input signal, and the applying attribute of the repetitive input signal. The “B m/s” can be controlled through the applying attribute set item of the repetitive input signal in the repetitive input signal set screen illustrated in FIG. 2. Therefore, the B m/s can be identical with the A m/s or can have other values according to the setting.

In the meantime, when a user generates a specific input signal, e.g., a tap event corresponding to the touch-down event and the touchup event by using the touch screen 140, or generates a specific input signal by using the input unit 120 while the image of the items is automatically scrolled according to the generated repetitive input signal, the function of being automatically scrolled can be stopped. At this time, although the automatic scroll function is stopped, the controller 160 can control the non-deletion of the information relating to the automatic scroll function stored in the buffer 151 and store it for a certain time. And the controller 160 controls the re-performance of the automatic scroll function according to an input signal commanding to perform again the automatic scroll function, e.g., the generation of a touch event for re-performance or according to the generation of a specific input signal generated from the input unit 120.

The controller 160 can remove the automatic scroll function related information stored in the buffer 151 when an input signal for the re-performance of the automatic scroll function is not generated for a certain time or an input signal for the unlocking of the automatic scroll function is generated. As illustrated above, the user interface for the input signal process of the portable device 100 according to an exemplary embodiment of the present invention supports a user setting the repetitive input signal, can comfortably and easily perform the operation of portable device 100 by applying the repetitive input signal when the specific application is activated according to set conditions. In the above, the configuration of the portable device 100, the function and role of each configuration, and a user interface for supporting a user according to an exemplary embodiment of the present invention were illustrated. Hereinafter, a method of processing an input signal being performed based on the apparatus for processing an input signal according to an exemplary embodiment of the present invention is illustrated in detail with reference to drawing.

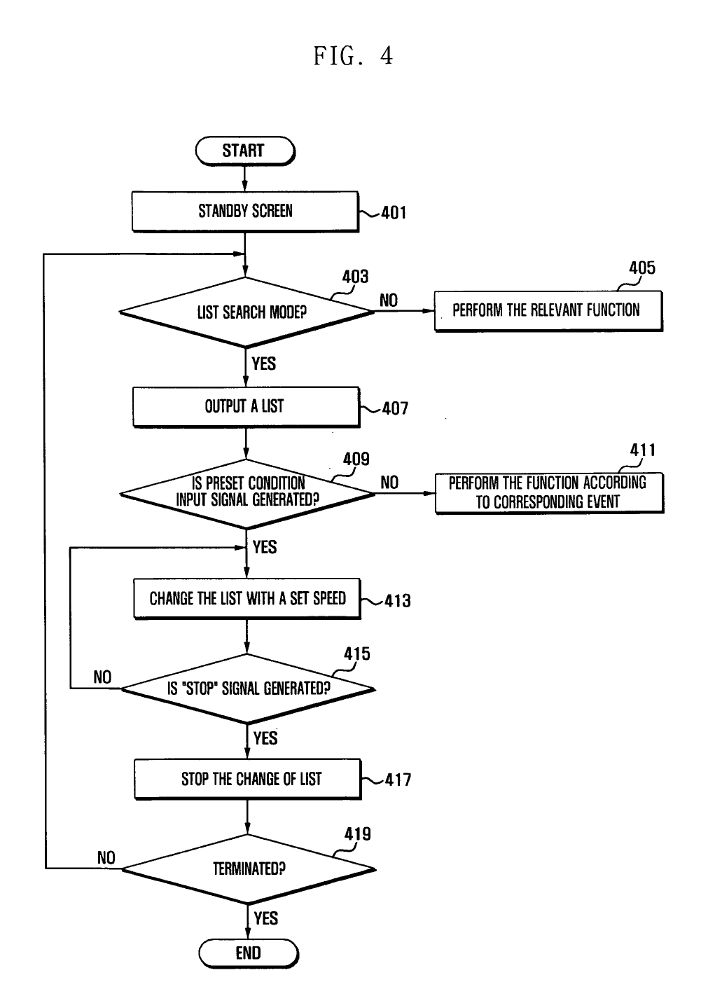

FIG. 4 is a flowchart illustrating a method of processing an input signal of a portable device according to an exemplary embodiment of the present invention. In the description that follows, it is assumed that the repetitive input signal generation mode is activated regardless of the type of the currently activated application.

Referring to FIGS. 1 to 4, in the method of processing an input signal of the present invention, when power is supplied, the controller 160 of the portable device 100 can initialize each configuration for the supplied power, and can output a stand-by screen to the display unit 141 according to a preset schedule (401). Thereafter, when an input signal is generated from at least one of the input unit 120 and the touch screen 140, the controller 160 determines whether the generated input signal is to be used for the list search mode (403). When the generated input signal is not an input signal for entering the list search mode at block 403, the controller 160 controls the performance of a function according to an input signal such as the relevant function including the portable device 100, e.g., the call function, the web access function, the watching TV function, and the input signal including the short distance communications function (405).

In the meantime, when the generated input signal is an input signal for entering the list search mode at block 403, the controller 160 controls the output of a list to the display unit 141 (407). For instance, when a user selects the menu item for the search of a music file list or activates a specific key by using at least one of the input unit 120 and the touch screen 140 at block 403, the controller 160 can control an output of the list having music files as an item to the display unit 141 at block 407.

In the meantime, when the music file list is outputted to the display unit 141, the user can generate various input signals by using at least one of the input unit 120 and the touch screen 140. For instance, the user can generate a sweep event for the music file list search based on the touch screen 140, generate a touch-down event for selecting a specific item, or generate a touch event for changing the sequence of the items. Moreover, the user can generate an input signal for the search and selection of the music file list and the performance of other function controls by using not only the touch screen 140 but also the input unit 120. And then, the controller 160 checks whether a preset condition input signal is included among the generated input signals (409). For instance, the controller 160 can check whether the hold event (hold) and the touchup event (off) are generated. Here, the controller 160 controls the performance of the function according to the generated input signal when a preset condition input signal does not exist among the generated input signals (411). For instance, the controller 160 can change the image of the items outputted on the display unit 141 according to the sweep event, and can delete a specific music file item according to a specific input signal. In the meantime, when the preset condition input signal is included among the generated input signals at block 409, the controller 160 checks a preset repetitive input signal corresponding to the condition input signal, and can control the change of the list outputted on the display unit 141 according to a preset repetitive input signal applying attribute (413). Here, as described in FIG. 2, the repetitive input signal applying attribute can be a change speed of image corresponding to the list outputted to the display unit 141. The controller 160 controls the image change of the list outputted to the display unit 141 according to the repetitive input signal applying attribute, and then, checks whether a touch event or an input signal corresponding to a “stop” signal for stopping the image change of the list outputted to the display unit 141 is generated (415).

When the signal for stopping the image change of the list outputted to the display unit 141 is not generated from at least one of the input unit 120 and the touch screen 140 at block 415, the controller 160 returns to block 413 and can repetitively perform next processes. In the meantime, when the signal for stopping the image change of the list outputted to the display unit 141 is generated from at least one of the input unit 120 and the touch screen 140 at block 415, the controller 160 controls a stop of the image change of the list outputted to the display unit 141 (417). The controller 160 checks whether the portable device 100 is terminated (419). In a case where the input signal for the termination of portable device 100 is not generated, the controller 160 returns to block 403 and can repetitively perform next processes.

As described above, in the method of processing an input signal of the portable device 100 according to an exemplary embodiment of the present invention, it is determined whether a signal satisfying a condition input signal is generated among the generated input signals after entering the repetitive input signal generation mode when a specific application is activated, and thereby, the repetitive input signal is applied to the current application. Accordingly, a user can generate a specific repetitive input signal for the generation of a repetitive input signal without repetitively controlling the input unit 120 or the touch screen 140, so that the user can conveniently control the device.

In the meantime, in the above description, the items outputted to the display unit 141 were illustrated as a semicircular shape arrangement where respective items are overlapped in a certain portion, but the present invention is not limited to this. That is, the list type outputted on the display unit 141 of the present invention can be applicable to the list screen configured of a multi-row single-column, a multi-column single-row, and a multi-row multi-column of cross stripes. Moreover, the above-described portable device 100 can include elements which are not mentioned in the above, such as a local area communications module for the local area communications, a camera module for taking a picture of static image/moving picture of a subject, an interface for transmitting and receiving data by the wire communications or the wireless communications of the portable device 100, an Internet communications module for communicating with an Internet network and performing Internet functions, and a digital broadcasting module for performing the reception and playing of digital broadcasts.

The deformation of those elements is too various according to the convergence trend of the digital device to be enumerated, but elements similar to the above mentioned elements can be further included in the portable device 100. Moreover, in the portable device 100 of the present invention, it is obvious that a specific element can be excluded from the above mentioned configuration or can be replaced with other element. This can be easily understood for a person skilled in the art. Moreover, the portable device 100 according to the embodiment of the present invention may include all types of devices supporting the list scroll function. For instance, the portable device 100 can include all kinds of information telecommunications terminals, multimedia devices, and application devices thereof, such as a Portable Multimedia Player (PMP), a digital broadcasting player, a Personal Digital Assistant (PDA), a music player (e.g., MP3 player), a portable gaming terminal, a smart phone, a notebook computer, and a handheld PC, as well as all mobile communications terminals operating based on communication protocols corresponding to various communications systems.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of processing an input signal of a portable device, the method comprising:
collecting an input signal generated from at least one of an input unit and a touch screen;
generating a preset repetitive input signal when the collected input signal corresponds to a preset condition input signal; and
using an application that is currently activated based on the repetitive input signal.

2. The method of claim 1, further comprising entering a repetitive input signal generation mode when the application is activated.

3. The method of claim 1, further comprising at least one of:
setting a type of repetitive input signal to be applied to the application;
setting a type of condition input signal by which the repetitive input signal can be generated;
setting a change attribute of a screen outputted by the application according to the repetitive input signal; and
selecting an application applying the repetitive input signal generation mode.

4. The method of claim 2, wherein generating a preset repetitive input signal comprises:
storing an input signal for a scroll function in a buffer when the input signal is the input signal for the scroll function; and
sending the input signal for the scroll function stored in the buffer to a controller according to a given period and generating a scroll related repetitive input signal.

5. The method of claim 4, wherein using an application that is currently activated comprises: changing a display state of a plurality of items outputted on a display unit according to the scroll related repetitive input signal sent according to the given period when the application is a list search application.

6. The method of claim 5, further comprising:
receiving a preset touch event or an input signal for stopping the display state change of the items from the input unit or the touch screen; and
stopping the display state change according to the reception of the touch event or the input signal.

7. The method of claim 6, further comprising:
re-executing the display state change stopped when the preset touch event or input signal is generated in a state where the display state change is stopped.

8. The method of claim 1, wherein generating a preset repetitive input signal comprises: generating a repetitive input signal for an automatic scroll function when a sweep event, a hold event, and a touchup event are generated from the touch screen.

9. A portable device for processing an input signal, comprising:
at least one of an input unit and a touch screen configured to generate an input signal; and
a controller configured to collect the input signal, generate a preset repetitive input signal when the collected input signal corresponds to a preset condition input signal, and use an application that is currently activated based on the repetitive input signal.

10. The portable device of claim 9, further comprising: a storage configured to store information set to enter a repetitive input signal generation mode when the application is activated.

11. The portable device of claim 10, wherein the storage comprises a buffer configured to store the repetitive input signal.

12. The portable device of claim 9, further comprises a display unit configured to output an interface for performing an at least one operation among a type setting operation of the repetitive input signal to be applied to the application, a type setting operation of a condition input signal by which the repetitive input signal can be generated, a change attribute setting operation of a screen outputted by the application according to the repetitive input signal, and an operation of selecting an application applying the repetitive input signal generation mode.

13. The portable device of claim 9, further comprising a display unit configured to change a display state of a plurality of items according to a repetitive input signal for a scroll function sent according to a given period when the application is a list search application.

14. The portable device of claim 13, wherein at least one of the input unit and the touch screen is configured to generate a touch event or an input signal for stopping a display state change of the items according to a user's input, and send the touch event to the controller.

15. The portable device of claim 14, wherein the display unit is configured to change the stopped display state change when a preset touch event or an input signal is generated in a state where the display state change is stopped.

16. The portable device of claim 9, wherein the controller is configured to generate a repetitive input signal for automatic scroll function when a sweep event, a hold event, and a touchup event are generated from the touch screen.

17. A portable device comprising:
a controller configured to:
collect an input signal;
generate a preset repetitive input signal when the collected input signal corresponds to a preset condition input signal; and
execute an application that is currently activated based on the repetitive input signal.

18. The portable device of claim 17, further comprising entering a repetitive input signal generation mode when the application is activated.

19. The portable device of claim 17, wherein the controller is further configured to:
set a type of repetitive input signal to be applied to the application;
set a type of condition input signal by which the repetitive input signal can be generated;
set a change attribute of a screen outputted by the application according to the repetitive input signal; and
select an application applying the repetitive input signal generation mode.

20. The portable device of claim 18, wherein when generating a preset repetitive input signal, the controller is further configured to:
store an input signal for a scroll function in a buffer when the input signal is the input signal for the scroll function; and
send the input signal for the scroll function stored in the buffer to a controller according to a given period and generating a scroll related repetitive input signal.
